(19) United States
(12) Patent Application Publication
(10) Pub. No.: US 2021/0388292 A1
(43) Pub. Date: Dec. 16, 2021

(54) NON-AQUEOUS GEL DETERGENT COMPOSITIONS

(71) Applicant: RECKITT BENCKISER FINISH B.V., Hoofddorp (NL)

(72) Inventors: Amra BAJRAMOVIC, Heidelberg (DE); Caroline Sabina RIGOBERT, Heidelberg (DE); Claudia SCHMAELZLE, Heidelberg (DE)

(73) Assignee: RECKITT BENCKISER FINISH B.V., Hoofddorp (NL)

(21) Appl. No.: 17/291,782

(22) PCT Filed: Nov. 15, 2019
(86) PCT No.: PCT/EP2019/081475

§ 371 Date: May 6, 2021

(30) Foreign Application Priority Data
Nov. 19, 2018 (GB) 1818827.6

(51) Int. Cl. C11D 3/37; C11D 1/66; C11D 3/00; C11D 17/00; C11D 17/04

(52) U.S. Cl. CPC C11D 3/3715; C11D 1/66; C11D 17/043; C11D 17/003; C11D 3/0047

(57) ABSTRACT

A method for manufacturing an automatic dishwashing composition in the form of a non-aqueous gel, the method comprising: (i) combining one or more non-ionic surfactants, a polar non-aqueous solvent and a rheology modifier to form a non-aqueous gel, the non-aqueous gel having a pH of less than 7 when measured as a dilution of 1 part in 100 parts of water by weight, wherein the rheology modifier is an alkali-swellable emulsion polymer or a hydrophobically-modified alkali-swellable emulsion polymer; and (ii) adding to the non-aqueous gel one or more active agents selected from the group consisting of builders, surfactants, polymers, enzymes, bleaching agents, bleach activators, bleach catalysts and corrosion inhibitors to form the automatic dishwashing composition.

### COMPOSITION

The present invention relates to an automatic dishwashing composition and method of preparation thereof. In particular, the present invention relates to a non-aqueous gel that can be used to provide an automatic dishwashing composition in gel comprising significant quantities of a range of active ingredients without being susceptible to phase separation or yellowing, and preferably while maintaining a transparent or translucent aesthetic.

Unit dose detergent products are convenient for consumers, since there is no need for them to measure out the required volume of detergent each time. Various unit dose formats, including tablets, and containers made of water-soluble material, are already known. Water-soluble containers are attractive since they avoid direct consumer contact with the detergent contents, which are potentially irritant, and can have a faster dissolution profile than tablets (because the detergent contents do not need to be compacted particles). Fast dissolution in the wash is often required to release active ingredients from dosage units to be consumed in a single dishwasher run, so that they can become effective as soon as possible, for instance before they are deactivated by the high temperatures of the wash. Containers are preferred for this reason, and also since they are capable of incorporating many more types of composition including liquid, gel and paste compositions, not just solid ones. With multi-compartment containers, more than one type of composition can be incorporated (e.g. one solid and one liquid composition), incompatible ingredients can be kept separate until use, compartments can be designed to release their respective contents at different times in the wash, and/or greater opportunities for improved aesthetics are provided.

In practice in the automatic dishwashing (“ADW”) field, the choice of available sizes and shapes of unit dose products is limited by the size and shape of machine dispensers into which they are to be placed. There is also a general demand in the art for more concentrated products which use less packaging and/or confer better performance by including higher amounts of active ingredients. It would therefore be useful to have a compact ADW unit dose detergent composition containing a high level of ingredients contributing to the performance. When dealing with containers made from water-soluble material (such as polyvinyl alcohol), it is also important to ensure this material does not dissolve or deteriorate prior to the intended usage point of the container. Adverse interactions between the container material and the container contents during storage can potentially lead to container deformation and loss of mechanical strength of the product as well as rendering it unattractive. For these reasons it is helpful for the detergent formulation inside the container to have a low water content. When space is an issue, it is also important to minimise the levels of carriers not contributing to performance in the wash, such as water. Moreover, in multicompartment formats it is also not possible to have a powder next to a water-based gel because the water will migrate through the polyvinyl alcohol into the powder, causing heavy swelling of the compartment and degradation of actives like bleaching agents and enzymes.

Gel formats are particularly attractive to consumers, since their relatively high viscosity gives the appearance of highly concentrated actives. Transparent gels in particular are considered attractive because they communicate shine and fast dissolution. A monodose product containing a transparent gel and a powder in a water-soluble injection-moulded container or thermoformed pouch would combine all of the aforementioned benefits. To achieve cleaning and shine performance, the product needs to contain significant quantities of active ingredients such as builders, co-builders, surfactants, polymers, enzymes, bleaching compounds and sometimes anti-corrosion or glass-protecting agents. Moreover, at least some of the actives need to be in the gel phase to achieve the required performance of the multi-benefit product.

To date, however, commercially available monodose gels containing high levels of actives (e.g. builders) have had an opaque aesthetic due to the poor solubility of the actives in the non-aqueous gel phase. The types and amounts of active ingredients that can be included are also constrained by the risk of gel instability and phase separation due to the solubility issue. There is therefore a need in the art for a non-aqueous ADW gel that can include significant quantities of a range of active ingredients while remaining stable with respect to phase separation. It would be preferred that the product is also transparent or translucent.

WO 2016/001327 discloses a method of manufacturing an ADW product comprising manufacturing a gel phase by polymerising monomer(s) in a non-aqueous reaction mixture comprising a non-ionic surfactant to form a polymeric builder. The resulting gel, which is provided as a discrete dosage unit, can include high levels of the polymeric builder while maintaining a transparent or translucent aesthetic and without being susceptible to phase separation. However, there remains a need for an ADW gel that is similarly visually appealing while allowing greater flexibility in terms of the active ingredients to be incorporated.

Alkali-swellable emulsion (ASE) polymers and hydrophobically-modified alkali-swellable emulsion (HASE) polymers are known rheology modifiers that are used in various technical fields. Examples include the Acusol® rheology modifiers that have been suggested for their use in household and industrial applications. ASE and HASE polymers are widely considered to require neutralisation with inorganic bases or organic amines in order to thicken. In particular, the addition of the neutraliser is thought to lead to swelling due to charge-charge repulsion of the negative charges that form on the (H)ASE molecule as a result of the addition of the neutralising agent. EP 2865741, for example, discloses laundry detergents comprising HASE polymers using monoethanolamine (MEA) as a neutralising agent.

The present inventors have found that while (H)ASE polymers can be used to prepare non-aqueous ADW gels that can incorporate a variety of active agents in significant quantities without leading to phase separation, the gel turns yellow after a few days due to the presence of the organic amine neutralising agent. While inorganic bases are not associated with yellowing, they need to be added as a dilute aqueous solution to ensure uniform thickening of the (H)ASE polymer and therefore cannot be used in the preparation of a non-aqueous ADW gel. Accordingly, there remains a need for a non-aqueous ADW gel that can incorporate significant quantities of a variety of active ingredients, without being susceptible to phase separation or yellowing upon storage. It would be especially desirable if this could be achieved while maintaining a transparent or translucent aesthetic.

Accordingly, it is one object of the present invention to provide a non-aqueous gel for preparing an automatic dishwashing composition that can include significant quantities of a range of active ingredients, without being susceptible to phase separation or yellowing upon storage.

It is an alternative and/or additional object of the present invention to provide a non-aqueous gel preparing an automatic dishwashing composition that can include significant quantities of a range of active ingredients, while maintaining a transparent or translucent aesthetic.

It is an alternative and/or additional object of the present invention to provide a multi-compartment mono-dose ADW product comprising a non-aqueous gel, wherein the non-aqueous gel can include significant quantities of a range of active ingredients without being susceptible to phase separation or yellowing upon storage, preferably while maintaining a transparent or translucent aesthetic.

According to a first aspect, the present invention provides a method for manufacturing an automatic dishwashing composition in the form of a non-aqueous gel, the method comprising:

(i) combining one or more non-ionic surfactants, a polar non-aqueous solvent and a rheology modifier to form a non-aqueous gel, the non-aqueous gel having a pH of less than 7 when measured as a dilution of 1 part in 100 parts of water by weight,
wherein the rheology modifier is an alkali-swellable emulsion polymer or a hydrophobically-modified alkali-swellable emulsion polymer; and

(ii) adding to the non-aqueous gel one or more active agents selected from the group consisting of builders, surfactants, polymers, enzymes, bleaching agents, bleach activators, bleach catalysts and corrosion inhibitors to form the automatic dishwashing composition.

The present inventors have surprisingly found that by combining the (H)ASE polymer with one or more non-ionic surfactants and a polar non-aqueous solvent, it is possible to achieve thickening of the rheology modifier to form a gel without requiring the addition of an alkaline neutraliser. The gel is sufficiently stable that a range of active agents can be added without leading to gel instability and phase separation. Accordingly, a stable non-aqueous ADW gel that is not susceptible to yellowing or phase separation on storage is obtained.

According to a second aspect, the present invention provides an automatic dishwashing composition or an automatic dishwashing product obtainable or obtained by the method of the first aspect.

According to a third aspect, the present invention provides an automatic dishwashing composition in the form of a non-aqueous gel comprising one or more non-ionic surfactants, a polar non-aqueous solvent and a rheology modifier,
wherein the rheology modifier is an alkali-swellable emulsion polymer or a hydrophobically-modified alkali-swellable emulsion polymer, and
wherein the composition comprises at most 1 wt % of an organic amine base based on the weight of the rheology modifier.

According to a fourth aspect, the present invention provides an automatic dishwashing product comprising the automatic dishwashing composition of the second or third aspects.

According to a fifth aspect, the present invention provides the use of an automatic dishwashing composition or automatic dishwashing product according to the second, third or fourth aspects in an automatic dishwashing process.

According to a sixth aspect, the present invention provides a non-aqueous gel for use in the preparation of an automatic dishwashing composition, the non-aqueous gel comprising one or more non-ionic surfactants, a polar non-aqueous solvent and a rheology modifier,
wherein the rheology modifier is an alkali-swellable emulsion polymer or a hydrophobically-modified alkali-swellable emulsion polymer, and
wherein the non-aqueous gel has a pH of less than 7 when measured as a dilution of 1 part in 100 parts of water by weight.

The present invention will now be described further. In the following passages different aspects/embodiments of the invention are defined in more detail. Each aspect/embodiment so defined may be combined with any other aspect/embodiment or aspects/embodiments unless clearly indicated to the contrary. In particular, any feature indicated as being preferred or advantageous may be combined with any other feature or features indicated as being preferred or advantageous.

The present invention provides a method for manufacturing an automatic dishwashing composition in the form of a non-aqueous gel. By “non-aqueous” it is meant that the comprises substantially no water, preferably less than 20 wt % water by weight of the composition, more preferably less than 15 wt % water, still more preferably less than 10 wt % water. In some embodiments, the composition contains no water. However, a certain amount of water may be unavoidable, for instance if one or more of the components of the composition can only suitably be delivered as an aqueous solution or dispersion. For example, some commercially available (H)ASE polymers are supplied in the form of an aqueous emulsion. It is to be appreciated that the non-aqueous gel forms a continuous gel phase. Accordingly, finely divided gel pieces mixed into a particulate solid composition, or dispersed in a liquid, are not considered to be a continuous gel phase.

The method comprises combining one or more non-ionic surfactants, a polar non-aqueous solvent and a rheology modifier to form a non-aqueous gel. The term “non-aqueous” takes the same meaning as provided above, the weight percentages being by weight of the non-aqueous gel. Preferably, the combining step is performed at a temperature of 20 to 25° C. Preferably, the one or more non-ionic surfactants are liquid at 20° C. That is, the one or more non-ionic surfactants are liquid in their individual, isolated forms, prior to being combined with the polar non-aqueous solvent and the rheology modifier. Liquid non-ionic surfactants are preferred from the perspective of allowing transparency of the resulting gel.

Preferably, the one or more non-ionic surfactants are selected from optionally endcapped alcohol alkoxylates. Preferably, the one or more non-ionic surfactants are low-foaming.

In an embodiment, the alkyl alkoxylate is endcapped and is a mono- or di-(C₁-C₆alkyl)ether of a polyether polyol.

In an embodiment, the alkyl alkoxylate is an alkyl ethoxylate. In an embodiment the only alkylene oxide groups in the alkyl alkoxylate are ethoxylate groups. In another embodiment, the alkyl alkoxylate comprises propoxylate groups and/or butoxylate oxide groups, in addition to ethoxylate groups. Preferably, the alkoxylate portion of the alkyl alkoxylate is an adduct of ethoxylate and propoxylate groups.

Preferably, the alkyl group of the alkyl alkoxylate is a C₂ to C₂₀ alkyl group, preferably from C₁₀ to C₁₈, still more preferably from C₁₂ to C₁₅. In a preferred embodiment, the alkyl alkoxylate is a C₁₂-C₁₅ ethoxylate/propoxylate adduct.

In an embodiment, the optional end cap is a hydroxylated alkyl group, preferably a CH₂CH(OH)R group in which R is alkyl.

In an embodiment, the alkyl alkoxylate is of the formula R¹—O—(R²—O)ₓ—(R³—O)_{y}—R⁴, in which:
R¹ and R⁴ are independently H, optionally substituted alkyl or optionally substituted alkenyl, provided that both R¹ and R⁴ are not H;
R²—O and R³—O are different but each independently ethylene oxide, propylene oxide or butylene oxide; and
x and y are independently between 0 and 300 (representing the average degree of alkoxylation), with the proviso that at least one of x and y is non-zero.

Where x and y are both non-zero, the order of R²—O and R³—O groups may be varied such that this represents a random or block copolymer.

Preferably, one or more of the following criteria apply:
R¹ and R⁴ are independently H or optionally substituted alkyl, preferably H or optionally hydroxylated alkyl, preferably H or C₁-C₃₀ alkyl;
R¹ is C₃-C₂₅ alkyl, preferably C₄-C₂₂ alkyl, preferably C₅-C₂₀ alkyl, preferably C₆-C₁₈ alkyl, preferably C₇-C₁₅ alkyl;
R⁴ is H or C₁-C₁₀ alkyl, preferably H or C₂-C₆ alkyl, preferably H or C₃-C₄ alkyl;
R²—O is ethylene oxide and x is non-zero, but if R³—O is present, the order of alkoxylate groups may be varied;
x and y are independently between 0 and 100, preferably between 0.5 and 70, preferably between 0.7 and 50, preferably between 0.9 and 30, preferably between 1 and 20, preferably between 1.5 and 10;
the sum of x and y is at least 3, preferably at least 4, preferably at least 5;
R²—O is ethylene oxide and x is at least 3, preferably at least 4, at least 5, or at least 6;
R²—O is ethylene oxide, both x and y are non-zero, and x is greater than y, preferably x is at least double y.

A group of preferred non-ionic surfactants are the end-capped polyoxyalkylated non-ionics of formula R₁O[CH₂CH(R₃)O]ₓ[CH₂]ₖCH(OH)[CH₂]ⱼOR₂ where R₁ and R₂ represent linear or branched chain, saturated or unsaturated, aliphatic or aromatic hydrocarbon groups with 1-30 carbon atoms, R₃ represents a hydrogen atom or a methyl, ethyl, n-propyl, iso-propyl, n-butyl, 2-butyl or 2-methyl-2-butyl group, x is a value between 1 and 30 and, k and j are values between 1 and 12, preferably between 1 and 5. When the value of x is >2 each R₃ in the formula above can be different. R₁ and R₂ are preferably linear or branched chain, saturated or unsaturated, aliphatic or aromatic hydrocarbon groups with 6-22 carbon atoms, where groups with 8 to 18 carbon atoms are particularly preferred. For the group R₃, H, methyl or ethyl is particularly preferred. Particularly preferred values for x are comprised between 1 and 20, preferably between 6 and 15.

As described above, in case x>2, each R₃ in the formula can be different. For instance, when x=3, the group R₃ could be chosen to build ethylene oxide (R₃═H) or propylene oxide (R₃=methyl) units which can be used in every single order for instance (PO)(EO)(EO), (EO)(PO)(EO), (EO)(EO)(PO), (EO)(EO)(EO), (PO)(EO)(PO), (PO)(PO)(EO) and (PO)(PO)(PO). The value 3 for x is only an example and bigger values can be chosen whereby a higher number of variations of (EO) or (PO) units would arise. Particularly preferred end-capped polyoxyalkylated alcohols of the above formula are those where k=1 and j=1 originating molecules of simplified formula:

R₁O[CH₂CH(R₃)O]ₓCH₂CH(OH)CH₂OR₂

Preferably the alkyl alkoxylate is based on a fatty alcohol with a carbon C₈ to C₂₀ chain, wherein the fatty alcohol has been ethoxylated or propoxylated. The degree of ethoxylation is described by the number of ethylene oxide units (EO), and the degree of propoxylation is described by the number of propylene oxide units (PO). Such surfactants may also comprise butylene oxide units (BO) as a result of butoxylation of the fatty alcohol. Preferably, this will be a mix with PO and EO units. The surfactant chain can be terminated with a butyl (Bu) moiety.

Preferably the mixed alkoxylate fatty alcohol non-ionic surfactants comprise between 3 to 5 moles of the higher alkoxylate group and between 6 to 10 moles the higher lower group. Especially preferred are mixed alkoxylate fatty alcohol nonionic surfactants having 4 or 5 moles of the higher alkoxylate group and 7 or 8 moles of the lower alkoxylate group. According to one aspect of the invention a mixed alkoxylate fatty alcohol nonionic surfactant having 4 or 5 PO moles and 7 or 8 EO moles is especially preferred and good results have been obtained with for surfactants with 4 PO moles and 8 EO moles. In an especially preferred embodiment the mixed alkoxylate fatty alcohol nonionic surfactant is C₁₂-15 8EO/4PO (commercially available as Genapol EP 2584 ex Clariant, Germany).

Preferably, the polar non-aqueous solvent is a polyalkylene glycol. Preferably, the polyalkylene glycol has a weight average molecular weight of from 100 to 600 g/mol, more preferably from 300 to 500 g/mol, and most preferably about 400 g/mol. Preferably, the polyalkylene glycol is selected from the group consisting of a polyethylene glycol, a polypropylene glycol, a polybutylene glycol, and combinations of two or more thereof. More preferably, the polyalkylene glycol is a polyethylene glycol.

Preferably, the polyalkylene glycol is a homopolymeric polyalkylene glycol. The polyalkylene glycol may, however, be a copolymer of an alkylene glycol and one or more further monomer units. The polyalkylene glycol may, for example, be a copolymer of two alkylene glycols, for example ethylene glycol and propylene glycol. The copolymers used in the present invention may be block copolymers or random copolymers.

The polyalkylene glycol may be end-capped at one or both ends, for example with an alkoxy group. Preferably, the alkoxy group is represented by the formula RO wherein R is a C₁ to C₂₀ alkyl group, more preferably C₁ to C₁₀. Most preferably, the alkoxy group is a methoxy group.

It is to be understood that the polar non-aqueous solvent is a liquid at 20° C. That is, the polar non-aqueous solvent is a liquid in its individual, isolated form, prior to being combined with the one or more non-ionic surfactants and the rheology modifier.

The term “rheology modifier” as used herein refers to a compound or mixture of compounds that provide either a sufficient yield stress or low shear viscosity to stabilise the non-aqueous gel independently from, or extrinsic from, the structuring effect of any detersive surfactants in the gel. The rheology modifier used in the present invention is an alkali-swellable emulsion (ASE) polymer or a hydrophobically-modified alkali-swellable emulsion (HASE) polymer. A variety of HASE and ASE polymers are known in the art and are commercially available. Preferably, the rheology modifier is a copolymer comprising or consisting of acrylic acid monomer units and alkyl acrylate monomer units.

Preferably, the rheology modifier is a HASE polymer, preferably having the following structure:

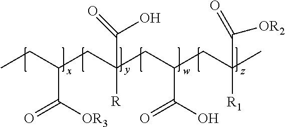

wherein R, R₁ and R₃ are independently selected from H and alkyl groups,

wherein R₂ is an optionally alkoxylated alkyl group, and

wherein w, x, y and z are integers.

In the above formula, R, R₁ and R₃ are preferably independently selected from C₁-C₁₀ alkyl groups, R₂ is preferably an ethoxylated C₁-C₂₀ alkyl group and R₃ is preferably selected from H and C₁-C₆ alkyl groups.

In the above formula, R and R₁ are most preferably methyl groups, R₂ is most preferably an ethoxylated C₈-C₂₀ alkyl group and R₃ is most preferably an ethyl group.

The repeating units comprising R, R₁, R₂ and R₃ can be in any suitable order, or even randomly distributed through the polymer chain.

Suitable HASE rheology modifiers can have a molecular weight of from 50,000 to 500,000 g/mol, preferably from 80,000 to 400,000 g/mol, more preferably from 100,000 to 300,000 g/mol.

The ratio of x:y can be from 1:20 to 20:1, preferably from 1:10 to 10:1, more preferably from 1:5 to 5:1. The ratio of x:w can be from 1:20 to 20:1, preferably from 1:10 to 10:1, more preferably from 1:5 to 5:1. The ratio of x:z can be from 1:1 to 500:1, preferably from 2:1 to 250:1, more preferably from 25:1 to 75:1.

Examples of suitable HASE rheology modifiers are ACUSOL™ 801S, ACUSOL™ 805S, ACUSOL™ 810, ACUSOL™ 820 ACUSOL™ 823 and ACUSOL™ Millennium sold by DOW.

Methods of making such HASE rheology modifiers are described in U.S. Pat. Nos. 4,514,552, and 5,192,592, British Patent No. 870,994, and U.S. Pat. No. 7,217,443, all of which are incorporated herein by reference.

Alternatively, the rheology modifier may be an ASE polymer, preferably having the following structure:

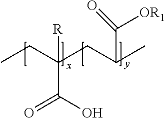

wherein R is selected from H and alkyl groups and R₁ is an alkyl group, and

wherein x and y are integers.

Preferably, R is selected from H and C₁-C₂₀ alkyl groups and R₁ is a C₁-C₂₀ alkyl group.

The ratio of x:y can be from 1:20 to 20:1, preferably from 1:10 to 10:1, more preferably from 1:5 to 5:1. The ratio of x:w can be from 1:20 to 20:1, preferably from 1:10 to 10:1, more preferably from 1:5 to 5:1. The ratio of x:z can be from 1:1 to 500:1, preferably from 2:1 to 250:1, more preferably from 25:1 to 75:1.

Suitable ASE rheology modifiers can have a molecular weight of from 50,000 to 500,000 g/mol, preferably from 80,000 to 400,000 g/mol, more preferably from 100,000 to 300,000 g/mol.

An example of a suitable ASE rheology modifier is ACUSOL™ 830 sold by DOW.

The non-aqueous gel formed by combining the one or more non-ionic surfactants, the polar non-aqueous solvent and the rheology modifier has a pH of less than 7 when measured as a dilution of 1 part in 100 parts of water by weight. Preferably the pH is measured at 20° C. Preferably, the non-aqueous gel has a pH of less than 6.5, more preferably from 4 to 6. Surprisingly, the present inventors have found that by combining these three components, it is possible to achieve thickening of the (H)ASE polymer to form a gel without requiring the addition of an alkaline neutraliser (e.g. an organic amine base). This is surprising because ASE and HASE polymers are widely considered to require neutralisation with inorganic bases or organic amines in order to thicken. The mechanism for the thickening of the (H)ASE polymer in the present invention, that is, without the addition of an alkaline neutralising agent, is currently unknown.

It is to be understood that the (H)ASE polymer of the present invention is used in its acidified, non-neutralised form. Moreover, it is to be understood that while the pH of the non-aqueous gel when measured as a dilution of 1 part in 100 parts of water by weight characterises the gel, the dilution itself not form part of the method of the invention. In other words, the gel is used in the subsequent step in its non-aqueous form, not as a dilution of 1 part in 100 parts of water by weight. This will be appreciated because the overall method relates to the manufacture of an automatic dishwashing composition in the form of a non-aqueous gel.

Preferably, the non-aqueous gel formed from the combination of the one or more non-ionic surfactants, the polar non-aqueous solvent and the rheology modifier comprises at most 1 wt % of an organic amine base based on the weight of the rheology modifier. Examples of organic amine bases include monoethanolamine (MEA) and monoisopropanolamine (MIPA). As explained above, the present inventors have surprisingly found that ASE and HASE polymers can be made to thicken to form a non-aqueous gel without adding an organic amine base. The inclusion of little or no organic amine base in the non-aqueous gel of the invention advantageously avoids the yellowing caused by such bases. Preferably, the non-aqueous gel comprises at most 0.5 wt % of an organic amine base based on the weight of the rheology modifier. Most preferably, the non-aqueous gel comprises no organic amine base.

Preferably, the non-aqueous gel formed from the combination of the one or more non-ionic surfactants, the polar non-aqueous solvent and the rheology modifier comprises at most 1 wt % of an organic base based on the weight of the rheology modifier, more preferably at most 0.5 wt %. Most preferably, the non-aqueous gel comprises no organic base.

The non-aqueous gel formed from the combination of the one or more non-ionic surfactants, the polar non-aqueous solvent and the rheology modifier preferably comprises from 20 to 35 wt % of the one or more non-ionic surfactants, from 55 to 75 wt % of the polar non-aqueous solvent and/or from 2 to 6 wt % of the rheology modifier, based on the total weight of the one or more non-ionic surfactants, polar non-aqueous solvent and rheology modifier. It has been found that including the components in these proportions helps to provide a transparent gel, which remains transparent or translucent even after the active ingredients have been added. This is particularly desirable from a consumer perspective. It is to be understood that the weight percentage for the rheology modifier refers to the weight percentage of the polymer itself, and does not include any other components that may be present in commercially available sources. For example, the Acusol® polymers listed above are sold an aqueous emulsion, and the weight percentage for the rheology modifier in the present invention does not include the water of the emulsion.

More preferably, the non-aqueous gel comprises from 3 to 5 wt % of the rheology modifier based on the total weight of the one or more non-ionic surfactants, polar non-aqueous solvent and rheology modifier, preferably from 4 to 5.5 wt %.

Preferably, the non-aqueous gel formed from the combination of the one or more non-ionic surfactants, the polar non-aqueous solvent and the rheology modifier is transparent or translucent, more preferably transparent. Transparency and translucency can be visually observed by the skilled person. In an embodiment, the non-aqueous gel is colourless and has a light transmission level TL (amount of transmitted light as a percentage of incident light) at 500 nm of at least 70%, preferably at least 75%, preferably at least 80%, preferably at least 85%, preferably at least 87%, preferably at least 90%, relative to distilled water which is designated as having a TL of 100%.

Preferably, the non-aqueous gel has a viscosity of at least 200 mPa·s as measured at 20° C. with a rotational rheometer (DHR-1 TA-Instruments, parallel discs, 0 40 mm, h=1 mm), preferably at least 400 mPa·s, at least 600 mPa·s, at least 800 mPa·s, at least 1000 mPa·s, at least 1500 mPa·s, at least 2000 mPa·s, at least 5000 mPa·s, at least 10,000 mPa·s, at least 20,000 mPa·s, at least 30,000 mPa·s, or at least 50,000 mPa·s.

In an embodiment, the non-aqueous gel has a viscosity of at least 100,000 mPa·s measured at 20° C., at least 500,000 mPa·s, at least 1,000,000 mPa·s, at least 5,000,000 mPa·s, or at least 10,000,000 mPa·s, at 20° C. as measured with a rotational rheometer (DHR-1 TA-Instruments, parallel discs, 0 40 mm, h=1 mm).

In an embodiment, the non-aqueous is self-standing, and does not flow at 20° C., 1 atm pressure. Such a gel is too viscous for reliable viscosity measurements to be made at 20° C. using a device such as a Brookfield viscosimeter.

The non-aqueous gel may be thermoreversible, and its viscosity when heated to 50° C. may desirably be less than 5000 mPa·s, less than 1000 mPa·s, less than 500 mPa·s, or less than 200 mPa·s, as measured with a Brookfield viscosimeter. This facilitates e.g. its filling into a container when heated to a pourable, lower viscosity liquid, and cooling to form a higher viscosity gel phase, especially a self-standing gel, which it would not be possible to pour at room temperature.

Having formed a non-aqueous gel from the combination of the one or more non-ionic surfactants, the polar non-aqueous solvent and the rheology modifier, the method then involves adding to the non-aqueous gel one or more active agents selected from the group consisting of builders, surfactants, polymers, enzymes, bleaching agents, bleach activators, bleach catalysts and corrosion inhibitors to form the automatic dishwashing composition. Preferably, the method involves adding two or more active agents selected from the aforementioned group, more preferably three or more. Preferably, the addition step is performed at a temperature of 20 to 25° C.

Preferably, the active agents are at least partially dissolved in the non-aqueous gel. Good solubility helps to maintain a transparent aesthetic.

Preferably, the one or more active agents are solid. By “solid” it is meant that the active agent(s) are solid at 20° C. in their isolated form, i.e. prior to their addition to the non-aqueous gel formed in the first step.

Builders

The one or more active agents may include one or more builders (or co-builders). The builder/co-builder may be either a phosphorous-containing builder or a phosphorous-free builder as desired. In many jurisdictions, phosphate builders are banned. Preferably, therefore, the automatic dishwashing composition is phosphate-free.

If phosphorous-containing builders are to be used, it is preferred that mono-phosphates, di-phosphates, tri-polyphosphates or oligomeric-polyphosphates are used. The alkali metal salts of these compounds are preferred, in particular the sodium salts. An especially preferred builder is sodium tripolyphosphate (STPP).

If a phosphorous-free builder is included, it preferably comprises an aminocarboxylate or a citrate. Most preferably, the builder is selected from the group consisting of methylglycine diacetic acid (MGDA), N,N-dicarboxymethyl glutamic acid (GLDA), citrate and combinations of two or more thereof. It is to be appreciated that the terms MGDA, GLDA and citrate encompass the free acids as well as salts, esters and derivatives thereof. Preferably, the citrate is trisodium citrate.

Other phosphorous-free builders include succinate based compounds. The terms “succinate based compound” and “succinic acid based compound” are used interchangeably herein.

Other suitable builders are described in U.S. Pat. No. 6,426,229, which is incorporated by reference herein. Particular suitable builders include; for example, aspartic acid-N-monoacetic acid (ASMA), aspartic acid-N,N-diacetic acid (ASDA), aspartic acid-N-monopropionic acid (ASMP), iminodisuccinic acid (IDA), N-(2-sulfomethyl) aspartic acid (SMAS), N-(2-sulfoethyl)aspartic acid (SEAS), N-(2-sulfomethyl)glutamic acid (SMGL), N-(2-sulfoethyl)glutamic acid (SEGL), N-methyliminodiacetic acid (MIDA), a-alanine-N,N-diacetic acid (a-ALDA), β-alanine-N,N-diacetic acid (β-ALDA), serine-N,N-diacetic acid (SEDA), isoserine-N,N-diacetic acid (ISDA), phenylalanine-N,N-diacetic acid (PHDA), anthranilic acid-N,N-diacetic acid (ANDA), sulfanilic acid-N,N-diacetic acid (SLDA), taurine-N, N-diacetic acid (TUDA) and sulfomethyl-N,N-diacetic acid (SM DA) and alkali metal salts or ammonium salts thereof.

Further preferred succinate compounds are described in U.S. Pat. No. 5,977,053, which is incorporated herein by reference, and have the formula:

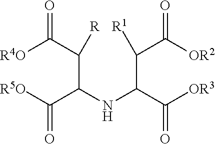

in which R, R¹, independently of one another, denote H or OH; R², R³, R⁴, R⁵, independently of one another, denote a cation, hydrogen, alkali metal ions and ammonium ions, ammonium ions having the general formula R⁶R⁷R⁸R⁹N⁺ and R⁶, R⁷, R⁸, R⁹, independently of one another, denote hydrogen, alkyl radicals having 1 to 12 C atoms or hydroxyl-substituted alkyl radicals having 2 to 3 C atoms.

Preferred examples include tetrasodium imminosuccinate. Iminodisuccinic acid (IDS) and (hydroxy)iminodisuccinic acid (HIDS) and alkali metal salts or ammonium salts thereof are especially preferred succinate based builder salts. The phosphorous-free co-builder may also or alternatively comprise non-polymeric organic molecules with carboxylic group(s). Builder compounds which are organic molecules containing carboxylic groups include citric acid, fumaric acid, tartaric acid, maleic acid, lactic acid and salts thereof. In particular the alkali or alkaline earth metal salts of these organic compounds may be used, and especially the sodium salts. An especially preferred phosphorous-free builder is sodium citrate. Such polycarboxylates which comprise two carboxyl groups include, for example, water-soluble salts of, malonic acid, (ethylenedioxy)diacetic acid, maleic acid, diglycolic acid, tartaric acid, tartronic acid and fumaric acid. Such polycarboxylates which contain three carboxyl groups include, for example, water-soluble citrate. Correspondingly, a suitable hydroxycarboxylic acid is, for example, citric acid.

Preferred secondary builders include homopolymers and copolymers of polycarboxylic acids and their partially or completely neutralized salts, monomeric polycarboxylic acids and hydroxycarboxylic acids and their salts, phosphates and phosphonates, and mixtures of such substances. Preferred salts of the abovementioned compounds are the ammonium and/or alkali metal salts, i.e. the lithium, sodium, and potassium salts, and particularly preferred salts is the sodium salts. Secondary builders which are organic are preferred. A polymeric polycarboxylic acid is the homopolymer of acrylic acid. Other suitable secondary builders are disclosed in WO 95/01416, to the contents of which express reference is hereby made. Most preferably, the secondary builder is trisodium citrate.

Surfactants

The one or more active agents may include one or more surfactants. Any of non-ionic, anionic, cationic, amphoteric or zwitterionic surface active agents or suitable mixtures thereof may be used. Many such suitable surfactants are described in Kirk Othmer's Encyclopedia of Chemical Technology, 3rd Ed., Vol. 22, pp. 360-379, “Surfactants and Detersive Systems”, incorporated by reference herein. In general, bleach-stable surfactants are preferred according to the present invention.

In the case of automatic dishwashing compositions, it is preferred to minimise the amount of anionic surfactant. Accordingly, preferably the composition comprises no more than 2 wt %, no more than 1 wt %, or no, anionic surfactant. Preferably the composition comprises no more than 5 wt %, no more than 1 wt %, or no, ionic surfactant of any type. Non-ionic surfactants are especially preferred instead for automatic dishwashing products.

Preferably, the non-ionic surfactant is an optionally endcapped alkyl alkoxylate, as set out above for the non-ionic surfactant used in the first step. However, the non-ionic surfactant here is preferably a solid active agent. In other words, the non-ionic surfactant here is solid at 20° C. in its isolated form, i.e. prior to its addition to the non-aqueous gel formed in the first step. This is to be contrasted with the non-ionic surfactant used in the first step, which is preferably a liquid at 20° C. The classification of surfactants by their physical state at 20° C. is typically a reflection of their molecular weight. In particular, higher molecular weight surfactants tend to be solid at 20° C.

Polymers

The one or more active agents may include one or more polymers. The polymers are intended to improve the cleaning performance of the automatic dishwashing composition. For example sulphonated polymers may be used. Preferred examples include copolymers of CH₂═CR¹CR²R³—O—C₄H₃R⁴—SO₃X wherein R¹, R², R³, R⁴ are independently 1 to 6 carbon alkyl or hydrogen, and X is hydrogen or alkali with any suitable other monomer units including modified acrylic, fumaric, maleic, itaconic, aconitic, mesaconic, citraconic and methylenemalonic acid or their salts, maleic anhydride, acrylamide, alkylene, vinylmethyl ether, styrene and any mixtures thereof. Other suitable sulfonated monomers for incorporation in sulfonated (co)polymers are 2-acrylamido-2-methyl-1-propanesulphonic acid, 2-methacrylamido-2-methyl-1-propanesulphonic acid, 3-methacrylamido-2-hydroxy-propanesulphonic acid, allysulphonic acid, methallysulphonic acid, 2-hydroxy-3-(2 propenyloxy)propanesulphonic acid, 2-methyl-2-propenen-1-sulphonic acid, styrenesulphonic acid, vinylsulphonic acid, 3-sulphopropyl acrylate, 3-sulphopropylmethacrylate, sulphomethylacrylamide, sulphomethylmethacrylamide and water soluble salts thereof. Suitable sulphonated polymers are also described in U.S. Pat. No. 5,308,532 and in WO 2005/090541, which are incorporated herein by reference.

Polymers intended to improve the cleaning performance of the automatic dishwashing product may also be included in the or each automatic dishwashing composition. For example sulphonated polymers may be used. Preferred examples include copolymers of CH₂═CR¹CR²R³—O—C₄H₃R⁴—SO₃X wherein R¹, R², R³, R⁴ are independently 1 to 6 carbon alkyl or hydrogen, and X is hydrogen or alkali with any suitable other monomer units including modified acrylic, fumaric, maleic, itaconic, aconitic, mesaconic, citraconic and methylenemalonic acid or their salts, maleic anhydride, acrylamide, alkylene, vinylmethyl ether, styrene and any mixtures thereof. Other suitable sulfonated monomers for incorporation in sulfonated (co)polymers are 2-acrylamido-2-methyl-1-propanesulphonic acid, 2-methacrylamido-2-methyl-1-propanesulphonic acid, 3-methacrylamido-2-hydroxy-propanesulphonic acid, allysulphonic acid, methallysulphonic acid, 2-hydroxy-3-(2 propenyloxy)propanesulphonic acid, 2-methyl-2-propenen-1-sulphonic acid, styrenesulphonic acid, vinylsulphonic acid, 3-sulphopropyl acrylate, 3-sulphopropylmethacrylate, sulphomethylacrylamide, sulphomethylmethacrylamide and water soluble salts thereof. Suitable sulphonated polymers are also described in U.S. Pat. No. 5,308,532 and in WO 2005/090541, which are incorporated herein by reference.

Enzymes

The one or more active agents may include one or more enzymes. It is preferred that the one or more enzymes are selected from proteases, lipases, amylases, cellulases and peroxidases, with proteases and amylases being most preferred. It is most preferred that protease and/or amylase enzymes are included in the compositions according to the invention as such enzymes are especially effective in dishwashing detergent compositions. Any suitable species of these enzymes may be used as desired. More than one species may be used.

Bleaching Agents, Bleach Activators and Bleach Catalysts

The one or more active agents may include one or more bleaching agents, preferably in combination with one or more bleach activators and/or one or more bleach catalysts. The bleaching agent is preferably selected from the group consisting of an oxygen-releasing bleaching agent, a chlorine-releasing bleaching agent and mixtures of two or more thereof. More preferably, the bleaching agent is or comprises an oxygen-releasing bleaching agent.

The bleaching agent may comprise the active bleach species itself or a precursor to that species. Preferably, the bleaching agent is selected from the group consisting of an inorganic peroxide, an organic peracid and mixtures of two or more thereof. The terms “inorganic peroxide” and “organic peracid” encompass salts and derivatives thereof. Inorganic peroxides include percarbonates, perborates, persulphates, hydrogen peroxide and derivatives and salts thereof. The sodium and potassium salts of these inorganic peroxides are suitable, especially the sodium salts. Sodium percarbonate and sodium perborate are most preferred, especially sodium percarbonate.

The one or more active agents may further comprise one or more bleach activators and/or bleach catalysts. Any suitable bleach activator may be included, for example TAED, if this is desired for the activation of the bleaching agent. Any suitable bleach catalyst may be used, for example manganese acetate or dinuclear manganese complexes such as those described in EP 1741774 A1, the contents of which are incorporated herein by reference. The organic peracids such as perbenzoic acid and peroxycarboxylic acids e.g. phthalimidoperoxyhexanoic acid (PAP) do not require the use of a bleach activator or catalyst as these bleaches are active at relatively low temperatures such as about 30° C.

Corrosion Inhibitors

The one or more active agents may include one or more corrosion inhibitors. Corrosion inhibitors may provide benefits against corrosion of glass and/or metal and the term encompasses agents that are intended to prevent or reduce the tarnishing of non-ferrous metals, in particular of silver and copper.

It is known to include a source of multivalent ions in detergent compositions, and in particular in automatic dishwashing compositions, for anti-corrosion benefits. For example, multivalent ions and especially zinc, bismuth and/or manganese ions have been included for their ability to inhibit such corrosion. Organic and inorganic redox-active substances which are known as suitable for use as silver/copper corrosion inhibitors are mentioned in WO 94/26860 and WO 94/26859. Suitable inorganic redox-active substances are, for example, metal salts and/or metal complexes chosen from the group consisting of zinc, manganese, titanium, zirconium, hafnium, vanadium, cobalt and cerium salts and/or complexes, the metals being in one of the oxidation states II, III, IV, V or VI. Particularly suitable metal salts and/or metal complexes are chosen from the group consisting of MnSO₄, Mn(II) citrate, Mn(II) stearate, Mn(II) acetylacetonate, Mn(II) [1-hydroxyethane-1,1-diphosphonate], V₂O₅, V₂O₄, VO₂, TiOSO₄, K₂TiF₆, K₂ZrF₆, CoSO₄, Co(NO₃)₂ and Ce(NO₃)₃. Any suitable source of multivalent ions may be used, with the source preferably being chosen from sulphates, carbonates, acetates, gluconates and metal-protein compounds. Zinc salts are specially preferred corrosion inhibitors.

Preferred silver/copper corrosion inhibitors are benzotriazole (BTA) or bis-benzotriazole and substituted derivatives thereof. Other suitable inhibitors are organic and/or inorganic redox-active substances and paraffin oil. Benzotriazole derivatives are those compounds in which the available substitution sites on the aromatic ring are partially or completely substituted. Suitable substituents are linear or branch-chain C₁₋₂₀ alkyl groups and hydroxyl, thio, phenyl or halogen such as fluorine, chlorine, bromine and iodine. A preferred substituted benzotriazole is tolyltriazole.

It is to be understood that after the step of adding to the non-aqueous gel one or more active agents selected from the group consisting of builders, surfactants, polymers, enzymes, bleaching agents, bleach activators, bleach catalysts and corrosion inhibitors to form the automatic dishwashing composition, no further polar non-aqueous solvent, non-ionic surfactant or rheology modifier are added. Accordingly, the composition preferably comprises from 20 to 35 wt % of the one or more non-ionic surfactants, from 55 to 75 wt % of the polar non-aqueous solvent and/or from 2 to 6 wt % of the rheology modifier, based on the total weight of the one or more non-ionic surfactants, polar non-aqueous solvent and rheology modifier.

More preferably, the composition comprises from 3 to 5 wt % of the rheology modifier based on the total weight of the one or more non-ionic surfactants, polar non-aqueous solvent and rheology modifier, preferably from 4 to 5.5 wt %.

Preferably, the composition comprises the one or more non-ionic surfactants, the polar non-aqueous solvent and the rheology modifier in a total amount of at least 50 wt % based on the weight of the composition, and the one or more active agents in a total amount of up to 50 wt % based on the weight of the composition. More preferably, the composition comprises the one or more non-ionic surfactants, the polar non-aqueous solvent and the rheology modifier in a total amount of at least 60 wt % and the one or more active agents in a total amount of up to 40 wt %. Still more preferably, the composition comprises the one or more non-ionic surfactants, the polar non-aqueous solvent and the rheology modifier in a total amount of from 60 to 80 wt % and the one or more active agents in a total amount of from 20 to 40 wt %. Still more preferably, the composition comprises the one or more non-ionic surfactants, the polar non-aqueous solvent and the rheology modifier in a total amount of from 60 to 70 wt % and the one or more active agents in a total amount of from 30 to 40 wt %. As explained above, significant quantities of a range of active agents can be incorporated into the non-aqueous gel without leading to gel instability and phase separation.

Preferably, the composition is transparent or translucent, more preferably transparent, as set out above for the non-aqueous gel formed from the first step. Preferably, the composition remains transparent or translucent upon storage for at least 3 months at 30° C. and 65% relative humidity. Preferably, storage involves filling a PVOH pouch with the composition, sealing the pouch, and storing the sealed pouch in a closed outer package in a climate chamber under the aforementioned conditions. Preferably, the composition remains transparent or translucent upon storage for at least 3 months at 40° C. and 75% relative humidity.

Preferably, the composition is phase stable with respect to phase separation upon storage for at least 3 months at 30° C. and 65% relative humidity. Preferably, the storage is as defined above. Whether or not phase separation has occurred can be judged by the skilled person. Preferably, the composition is phase stable with respect to phase separation upon storage for at least 3 months at 40° C. and 75% relative humidity

Preferably, the composition has a viscosity of at least 200 mPa·s as measured at 20° C. with a rotational rheometer (DHR-1 TA-Instruments, parallel discs, 0 40 mm, h=1 mm), preferably at least 400 mPa·s, at least 600 mPa·s, at least 800 mPa·s, at least 1000 mPa·s, at least 1500 mPa·s, at least 2000 mPa·s, at least 5000 mPa·s, at least 10,000 mPa·s, at least 20,000 mPa·s, at least 30,000 mPa·s, or at least 50,000 mPa·s.

In an embodiment, the composition has a viscosity of at least 100,000 mPa·s measured at 20° C., at least 500,000 mPa·s, at least 1,000,000 mPa·s, at least 5,000,000 mPa·s, or at least 10,000,000 mPa·s, at 20° C. as measured with a rotational rheometer (DHR-1 TA-Instruments, parallel discs, 0 40 mm, h=1 mm).

In an embodiment, the composition is self-standing, and does not flow at 20° C., 1 atm pressure. Such a composition is too viscous for reliable viscosity measurements to be made at 20° C. using a device such as a Brookfield viscosimeter.

Preferably, the method further comprises incorporating the composition into an automatic dishwashing product, wherein the product is provided in a unit dosage form, and/or housed within a water-soluble or water-dispersible film or container, preferably a polyvinyl alcohol film or container.

These product forms are discussed below.

In an especially preferred embodiment, there is provided a method for manufacturing an automatic dishwashing composition in the form of a non-aqueous gel, the method comprising:

(i) combining one or more non-ionic surfactants, a polar non-aqueous solvent and a rheology modifier to form a non-aqueous gel, the non-aqueous gel having a pH of less than 6.5 when measured as a dilution of 1 part in 100 parts of water by weight,
wherein the rheology modifier is an alkali-swellable emulsion polymer or a hydrophobically-modified alkali-swellable emulsion polymer; and

(ii) adding to the non-aqueous gel one or more solid active agents selected from the group consisting of builders, surfactants, polymers, enzymes, bleaching agents, bleach activators, bleach catalysts and corrosion inhibitors to form the automatic dishwashing composition;
wherein the one or more non-ionic surfactants are selected from polyethylene glycols that are liquid at 20° C.,
wherein the polar non-aqueous solvent is a polyethylene glycol, optionally endcapped with a methoxy group, and
wherein the composition comprises the one or more non-ionic surfactants, the polar non-aqueous solvent and the rheology modifier in a total amount of from 60 to 80 wt % and the one or more solid active agents in a total amount of from 20 to 40 wt %.

According to a second aspect, the present invention provides an automatic dishwashing composition or an automatic dishwashing product obtainable or obtained by the method of the first aspect.

According to a third aspect, the present invention provides an automatic dishwashing composition in the form of a non-aqueous gel comprising one or more non-ionic surfactants, a polar non-aqueous solvent and a rheology modifier,
wherein the rheology modifier is an alkali-swellable emulsion polymer or a hydrophobically-modified alkali-swellable emulsion polymer, and
wherein the composition comprises at most 1 wt % of an organic amine base based on the weight of the rheology modifier.

It is to be understood that the organic amine base feature is optional, that is, the composition comprises from 0 to 1 wt % of an organic amine base based on the weight of the rheology modifier. Examples of organic amine bases include monoethanolamine (MEA) and monoisopropanolamine (MIPA). As explained above, the present inventors have surprisingly found that ASE and HASE polymers can be made to thicken to form a non-aqueous gel without adding an organic amine base. The inclusion of little or no organic amine base in the compositions of the invention advantageously avoids the yellowing caused by such bases. Preferably, the composition comprises at most 0.5 wt % of an organic amine base based on the weight of the rheology modifier. Most preferably, the composition comprises no organic amine base.

Preferably, the composition comprises at most 1 wt % of an organic base based on the weight of the rheology modifier, more preferably at most 0.5 wt %. Most preferably, the composition comprises no organic base.

Preferably, the composition further comprises one or more active agents selected from the group consisting of builders, surfactants, polymers, enzymes, bleaching agents, bleach activators, bleach catalysts and corrosion inhibitors. Suitable active agents are described above. Preferably, the one or more active agents are solid at 20° C. That is, the one or more active agents are solid at 20° C. in their isolated forms, i.e. prior to being added to the non-aqueous gel.

The preferred features of the composition described in relation to the first aspect are also preferred for the composition of the third aspect.

According to a fourth aspect, the present invention provides an automatic dishwashing product comprising the automatic dishwashing composition of the second or third aspects.

The automatic dishwashing product may comprise a plurality of compositions. For example, the product may comprise a composition in accordance with the second or third aspects in the form of a gel and at least one further composition in the form of a solid, liquid, gel or paste.

Preferably, the product is in a unit dose or monodose form. In other words, the product comprises one or more compositions in the quantity required for a single wash cycle of a machine dishwasher. The terms monodose and unit dose are used interchangeably throughout this disclosure.

In an embodiment, the detergent product is housed within a water soluble film or container, preferably a polyvinylalcohol (PVOH) film or container. The film or container may be prepared for example by injection moulding or thermoforming. The film or container may be a rigid capsule or film blister. The capsule or blister may have a single compartment or may be multi-compartment. Multi-compartment blisters or capsules may have different portions of the product in each compartment, or the same composition in each compartment. The distinct regions/compartments may contain any proportion of the total amount of ingredients as desired. The capsules or film blisters may be filled with tablets, powders, gels, pastes or liquids, or combinations of these, within the scope of the invention.

The film or container may be an injection moulded or thermoformed water soluble capsule with multiple compartments. Each compartment may comprise a different composition. Each compartment may be filled with a tablet, a powder, granules, a liquid, a gel, a paste, or combinations of two or more thereof.

Preferably, the automatic dishwashing product is housed within a water soluble film or container comprising at least three compartments, wherein one compartment contains an automatic dishwashing composition in accordance with the second or third aspects, one compartment contains an automatic dishwashing powder, and one compartment contains an automatic dishwashing liquid or gel.

According to a fifth aspect, the present invention provides the use of an automatic dishwashing composition or automatic dishwashing product according to the second, third or fourth aspects in an automatic dishwashing process.

According to a sixth aspect, the present invention provides a non-aqueous gel for use in the preparation of an automatic dishwashing composition, the non-aqueous gel comprising one or more non-ionic surfactants, a polar non-aqueous solvent and a rheology modifier,
wherein the rheology modifier is an alkali-swellable emulsion polymer or a hydrophobically-modified alkali-swellable emulsion polymer, and
wherein the non-aqueous gel has a pH of less than 7 when measured as a dilution of 1 part in 100 parts of water by weight.

The gel can be used to prepare an automatic dishwashing composition comprising significant quantities of a range of active ingredients without being subject to phase separation or yellowing, preferably while maintaining a transparent or translucent aesthetic. The gel itself is preferably transparent or translucent, more preferably transparent. The non-aqueous gel may itself be used in an automatic dishwashing product, for example as a machine cleaner.

The preferred features of the non-aqueous gel formed in the first step of the first aspect apply equally to the non-aqueous gel of the sixth aspect.

All percentages used in this disclosure are by weight unless otherwise specified.

The present invention will now be described in relation to the following non-limiting examples. It should be noted that in all of the examples, the amount of the Acusol component refers to the commercially available product, i.e. including the water of the aqueous emulsion, rather than just the polymer. The Acusol products used in the examples have a solids content of 28-30 wt %.

### EXAMPLE 1

The following non-aqueous gels were prepared, each comprising a polar non-aqueous solvent, a non-ionic surfactant and a HASE rheology modifier.

| Component | Amount (wt %) |
|---|---|
| PEG 400 | 51.5 |
| Fatty alcohol alkoxylate (Genapol ® EP 2584) | 28 |
| Acusol ® 805S | 18 |
| MIPA | Dose response |

(PEG=polyethylene glycol, MIPA=monoisopropanolamine)

The Acusol® 805S was provided as an emulsion containing 28-30 wt % solids.

The gels were prepared using the following method:
1. In a beaker, the PEG 400 was added; then Genapol® EP 2584 was added and the mixture was homogenized.
2. Acusol® 805S was added under agitation.
3. Optionally MIPA was added. The mixture was stirred under moderate agitation to avoid air bubbles.

The method was performed at room temperature.

The compositions were stored in a climate chamber for 1 week at 5° C. and 50% r.h. or 50° C. and 20% r.h. The compositions were stored (i) in a beaker/glass bottle with a lid and (ii) sealed in a multi-compartment PVOH pouch (with the pouch packed in a Doypack). The following colour changes were observed under both sets of conditions:

| Basis | w/o | 0.5% | 1% | 1.5% | 2.0% |
|---|---|---|---|---|---|
| gel | MIPA | MIPA | MIPA | MIPA | MIPA |
| start | colourless | colourless | colourless | colourless | colourless |
| 5° C./ | colourless | slightly | slightly | slightly | slightly |
| 1 week | | yellow | yellow | yellow | yellow |
| 50° C./ | colourless | yellow | yellow | yellow | Yellow |
| 1 week | | | | | |

It was found that even low amounts of MIPA (e.g. 0.5%) led to yellowing, even upon storage at 5° C. The gels including MIPA were transparent, whereas the gel without MIPA was found to be translucent. Nevertheless, it was surprising that the HASE rheology modifier gave rise to significant thickening in the absence of MIPA.

### EXAMPLE 2

Non-aqueous gel samples were prepared in accordance with the method of Example 1 containing 0% MIPA or 2.5% MIPA. In a final step, an automatic dishwashing active ingredient was blended into each gel sample by stirring with a spatula at room temperature.

The samples were stored for 1 week at 50° C. and 20% r.h under the conditions described in Example 1. The following colour changes were observed:

| | | | | | | | | Maleic acid- |
|---|---|---|---|---|---|---|---|---|
| | | | | | Modified Fatty | | | acrylic acid |
| | | | | | Alcohol | | | copolymer, |
| | | | | | Polyglycolether | | | sodium salt |
| | Sodium | Sodium | MGDA | Trisodium | (Dehypon GRA, | | | (Sokalan CP7, |
| Basis gel | Carbonate | Bicarbonate | granules | Citrate | BASF) | HEDP | TAED fine | BASF) |
| % w/w of | 30 | 30 | 30 | 30 | 10 | 5 | 5 | 5 |
| gel | | | | | | | | |
| with MIPA | yellow | Yellow | yellow | yellow | yellow | yellow | yellow | Yellow |
| without | slightly | colourless | yellow | colourless | dissolved, | colourless | colourless | slightly |
| MIPA | yellow | | | | colourless | | | yellow |

While the active ingredients did not fully dissolve (other than Dehypon GRA), they were all well-dispersed and provided a homogeneous gel without phase separation. Again, it was surprisingly found that the HASE rheology modifier gave rise to significant thickening in the absence of MIPA. Advantageously, the omission of MIPA eliminated or at least significantly reduced yellowing.

### EXAMPLE 3

Additional non-aqueous gels were prepared following the method of Example 1 to further investigate the effect of the HASE rheology modifier dosage on viscosity and transparency.

| | | | | | |
|---|---|---|---|---|---|
| Polar solvent- | 68.0% | 66.0% | 65.0% | 62.0% | 58% |
| PEG 400E | | | | | |
| Surfactant- | 20.0% | 20.0% | 20.0% | 20.0% | 20.0% |
| Genapol | | | | | |
| EP 2584 | | | | | |
| Rheology | 12.0% | 14.0% | 15.0% | 18.0% | 22% |
| modifier- | | | | | |
| Acusol 805 S | | | | | |

| | | | | |
|---|---|---|---|---|
| gel after | transparent | slightly | translucent | turbid |
| mixing | | translucent | | |
| gel stability | transparent | becomes | translucent | turbid |
| at RT | | transparent | | |
| | | when stirred, | | |
| | | but turns | | |
| | | again to | | |
| | | slightly | | |
| | | translucent | | |

The turbidity was found to increase as the amount of rheology modifier increased. Nevertheless, at 12 wt % the viscosity of the gel was found to be lower. Accordingly, the gel containing 14 wt % rheology modifier was most preferred.

### EXAMPLE 4

Additional non-aqueous gels were prepared to further investigate the effect of the HASE rheology modifier dosage on viscosity and transparency.

| | | | |
|---|---|---|---|
| Polar solvent-PEG 400E | 66.0% | 57.7% | 51.0% |
| Surfactant-Genapol EP 2584 | 20.0% | 28.3% | 35.0% |
| Rheology modifier-Acusol 805 S | 14.0% | 14.0% | 14.0% |

| | | |
|---|---|---|
| gel after mixing | transparent | turbid |
| gel stability at RT | transparent | turbid |

It was found that the amount of surfactant can be varied within a relatively broad range without adversely affecting the transparency or viscosity of the gel. However, above a certain surfactant concentration, the gel becomes turbid.

### EXAMPLE 5

A basis gel consisting of 66 wt % PEG 400E, 20 wt % Genapol EP 2584 and 14 wt % HASE/ASE polymer was prepared. The HASE/ASE polymer was varied and each gel was stored in the gel compartment of a thermoformed multi-compartment product for 1 week at 50° C. The gels were observed to have the following appearances:

| | | | | | Acusol |
|---|---|---|---|---|---|
| Polymer | Acusol 805S | Acusol 801S | Acusol 810 | Acusol 830 | Millennium |
| Observation | Transparent, | Transparent, | Transparent, | Transparent, | Transparent, |
| | colourless | colourless | colourless | colourless | colourless |

Acusol 830 is an ASE polymer, whereas the remainder are HASE polymers. Accordingly, the HASE and ASE polymer can be varied without compromising the transparency observed under these storage conditions.

### EXAMPLE 6

A three-compartment monodose automatic dishwashing product was prepared. In particular, a water-soluble, polyvinyl alcohol injection-moulded three-compartment container was prepared and filled with the following compositions, then sealed.

Gel Composition

| | |
|---|---|
| Fatty alcohol alkoxylate (Genapol EP 2584) | 19.43% |
| PEG 400 | 36.27% |
| Acusol 805S | 9% |
| Trisodium Citrate | 22% |
| Sodium Bicarbonate | 8% |
| HEDP 88, 5 | 2% |
| Amylase granules | 1% |
| Modified Fatty Acohol | 1.99% |
| Polyglycolether (Dehypon GRA, BASF) | |
| Dye | 0.01% |

The gel was prepared by first mixing the gel base according to the method described in Example 1, then adding the solids in the order as listed above while stirring with a propeller stirrer at 200-300 rpm at room temperature.

The gel was a transparent solid, present in Compartment 2 in a dosage of 4 g/wash.

Powder Composition

| | |
|---|---|
| Sodium Citrate | 11% |
| Sodium Percarbonate | 21% |
| Bleach Activators | 6% |
| (TAED, Catalyst) | |
| Sodium | 58% |
| carbonate/bicarbonate | |
| Polymers and | 9% |
| surfactants | |
| Enzymes | 1% |

The powder was present in Compartment 1 at a dosage of 9 g/wash.

Liquid Composition

| | |
|---|---|
| Non-ionic | 99.87% |
| surfactant | |
| Dye | 0.13% |

The liquid composition was present in Compartment 3 at a dosage of 0.7 g/wash.

Reference ADW Composition:

A reference formula with the following composition was prepared.

| | |
|---|---|
| Sodium Citrate | 14% |
| Percarbonate bleach, | 13% |
| activator and catalyst | |
| Bleach Activators | 6% |
| (TAED, Catalyst) | |
| Sodium | 55% |
| carbonate/bicarbonate | |
| Polymers and | 11% |
| surfactants | |
| Enzymes | 1% |

The reference formula was tested at a dosage of 14 g/wash.

Cleaning Performance

The cleaning performance of the automatic dishwashing product was tested according to the IKW method with reference to the control. The cleaning performance was found to be comparable.

Storage Stability

For the product in accordance with the invention:

No visual change was observed after 12 weeks at 25° C./50% r.h under the storage conditions of Example 1. A minor visual change was observed after 12 weeks at 40° C./75% r.h.—a minimal amount (3-4 drops) of liquid had separated from the gel.

The foregoing detailed description has been provided by way of explanation and illustration, and is not intended to limit the scope of the appended claims. Many variations in the presently preferred embodiments illustrated herein will be apparent to one of ordinary skill in the art, and remain within the scope of the appended claims and their equivalents.

1. A method for manufacturing an automatic dishwashing composition in the form of a non-aqueous gel, the method comprising:
combining one or more non-ionic surfactants, a polar non-aqueous solvent and a rheology modifier to form a non-aqueous gel, the non-aqueous gel having a pH of less than 7 when measured as a dilution of 1 part in 100 parts of water by weight,
wherein the rheology modifier is an alkali-swellable emulsion polymer or a hydrophobically-modified alkali-swellable emulsion polymer; and
(ii) adding to the non-aqueous gel one or more active agents selected from the group consisting of builders, surfactants, polymers, enzymes, bleaching agents, bleach activators, bleach catalysts and corrosion inhibitors to form the automatic dishwashing composition.

2. The method according to claim 1, wherein the one or more non-ionic surfactants are selected from optionally endcapped alcohol alkoxylates.

3. The method according to claim 1, wherein the one or more non-ionic surfactants are liquid at 20° C.

4. The method according to claim 1, wherein the polar non-aqueous solvent is a polyalkylene glycol.

5. The method according to claim 1, wherein the rheology modifier is a copolymer comprising acrylic acid monomer units and alkyl acrylate monomer units.

6. The method according to claim 1, wherein the rheology modifier is a hydrophobically-modified alkali-swellable emulsion polymer, having the following structure: 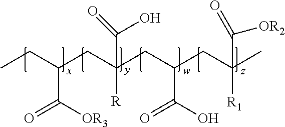
wherein R, R₁ and R₃ are independently selected from H and alkyl groups,
wherein R₂ is an optionally alkoxylated alkyl group, and
wherein w, x, y and z are integers.

7. The method according to claim 1, wherein the rheology modifier is an alkali-swellable emulsion polymer, having the following structure: 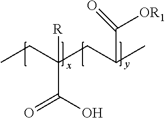
wherein R is selected from H and alkyl groups and R₁ is an alkyl group, and
wherein x and y are integers.

8. The method according to claim 1, wherein the composition comprises:
from 20 to 35 wt % of the one or more non-ionic surfactants;
from 55 to 75 wt % of the polar non-aqueous solvent; and/or
from 2 to 6 wt % of the rheology modifier, based on the total weight of the one or more non-ionic surfactants, polar non-aqueous solvent and rheology modifier.

9. The method according to claim 1, wherein the composition comprises the one or more non-ionic surfactants, the polar non-aqueous solvent and the rheology modifier in a total amount of at least 50 wt % based on the weight of the composition, and
wherein the composition comprises the one or more active agents in a total amount of up to 50 wt % based on the weight of the composition.

10. The method according to claim 1, wherein the composition is transparent or translucent.

11. The method according to claim 1, further comprising:
incorporating the composition into an automatic dishwashing product, wherein the product is provided in a unit dosage form, and/or housed within a water-soluble or water-dispersible film or container, preferably a polyvinyl alcohol film or container.

12. An automatic dishwashing composition or an automatic dishwashing product obtainable by the method of claim 1.

13. An automatic dishwashing composition in the form of a non-aqueous gel comprising one or more non-ionic surfactants, a polar non-aqueous solvent and a rheology modifier,
wherein the rheology modifier is an alkali-swellable emulsion polymer or a hydrophobically-modified alkali-swellable emulsion polymer, and
wherein the composition comprises at most 1 wt % of an organic amine base based on the weight of the rheology modifier.

14. The automatic dishwashing composition according to claim 13, wherein the composition further comprises one or more active agents selected from the group consisting of builders, surfactants, polymers, enzymes, bleaching agents, bleach activators, bleach catalysts and corrosion inhibitors.

15. The automatic dishwashing product comprising the automatic dishwashing composition of claim 12.

16. The automatic dishwashing product according to claim 15, wherein the product is:
in a unit dose form; and/or
housed within a water soluble or water dispersible film or container.

17. A method of using automatic dishwashing composition according to claim 12 in an automatic dishwashing process.

18. A non-aqueous gel for use in the preparation of an automatic dishwashing composition, the non-aqueous gel comprising one or more non-ionic surfactants, a polar non-aqueous solvent and a rheology modifier,
wherein the rheology modifier is an alkali-swellable emulsion polymer or a hydrophobically-modified alkali-swellable emulsion polymer, and
wherein the non-aqueous gel has a pH of less than 7 when measured as a dilution of 1 part in 100 parts of water by weight.

19. The method according to claim 10, wherein the composition remains transparent or translucent upon storage for at least 3 months at 30° C. and 65% relative humidity.

20. The method according to claim 11, wherein the water soluble or water dispersible film or container is a polyvinyl alcohol film or container.
